(19) United States
(12) Patent Application Publication
(10) Pub. No.: US 2016/0379060 A1
(43) Pub. Date: Dec. 29, 2016

(54) IMAGE SURVEILLANCE METHOD AND IMAGE SURVEILLANCE DEVICE THEREOF

(71) Applicant: VIVOTEK INC., New Taipei City (TW)

(72) Inventor: Wen-Yuan Li, New Taipei City (TW)

(21) Appl. No.: 15/170,902

(22) Filed: Jun. 1, 2016

(30) Foreign Application Priority Data
Jun. 24, 2015 (TW) 104120238

(51) Int. Cl. G06K 9/00; H04N 7/18; H04N 5/232

(52) U.S. Cl. CPC G06K 9/00771; H04N 5/23296; H04N 7/188

(57) ABSTRACT

An image surveillance method is applied to surveillance of a plurality of targets. The image surveillance method includes setting a priority of each target in advance, identifying at least one of the plurality of targets to obtain the priority of the at least one of the plurality of targets when the at least one of the plurality of targets enters at least one surveillance region, and determining whether to monitor the at least one of the plurality of targets according to the priority of the at least one of the plurality of targets.

### BACKGROUND OF THE INVENTION

1. Field of the Invention

The present invention relates to an image surveillance method and an image surveillance device thereof, and more specifically, to an image surveillance method for identifying a target and determining whether to preferentially monitor the target according to a priority of the target and an image surveillance device thereof.

2. Description of the Prior Art

In general, a surveillance camera with a pan-tilt-zoom function usually performs a dynamic surveillance operation on targets entering a surveillance region by an image analysis method (e.g. face identification, VCA (Video Content Analysis), or IVA (Intelligent Video Analysis))). For example, when a specific event (e.g. one target suddenly entering the surveillance region or running within the surveillance region) occurs in the surveillance region, the surveillance camera could start to perform the dynamic surveillance operation on this target.

However, if there are too many events occurring in the surveillance region, the surveillance camera may monitor other targets instead of monitoring a target of interest due to interference of these events. For example, when there are many targets in the surveillance region, surveillance images of the target of interest may be lost while the surveillance camera is performing the dynamic surveillance operation on the other targets (e.g. the target of interest may disappear in the captured surveillance images while the surveillance camera is performing the dynamic surveillance operation on the other targets). Thus, since the surveillance camera could not keep monitoring the target of interest, the surveillance camera is unable to provide the surveillance images of the target of interest to a user immediately when the user accesses the surveillance images captured by the surveillance camera.

### SUMMARY OF THE INVENTION

The present invention provides an image surveillance method for surveillance of a plurality of targets. The image surveillance method includes setting a priority of each target in advance, identifying at least one of the plurality of targets to obtain the priority of the at least one of the plurality of targets when the at least one of the plurality of targets enters at least one surveillance region, and determining whether to monitor the at least one of the plurality of targets according to the priority of the at least one of the plurality of targets.

The present invention further provides an image surveillance device. The image surveillance device includes at least one image surveillance unit and a processing unit. The at least one image surveillance unit is used for monitoring at least one surveillance region. The processing unit is electrically connected to the at least one image surveillance unit for setting a priority of each target, controlling the at least one image surveillance unit to identify at least one of a plurality of targets to obtain the priority of the at least one of the plurality of targets when the at least one of the plurality of targets enters the at least one surveillance region, and determining whether to control the at least one image surveillance unit to monitor the at least one of the plurality of targets according to the priority of the at least one of the plurality of targets.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image surveillance device according to an embodiment of the present invention.

FIG. 2 is a flowchart of an image surveillance method according to an embodiment of the present invention.

### DETAILED DESCRIPTION

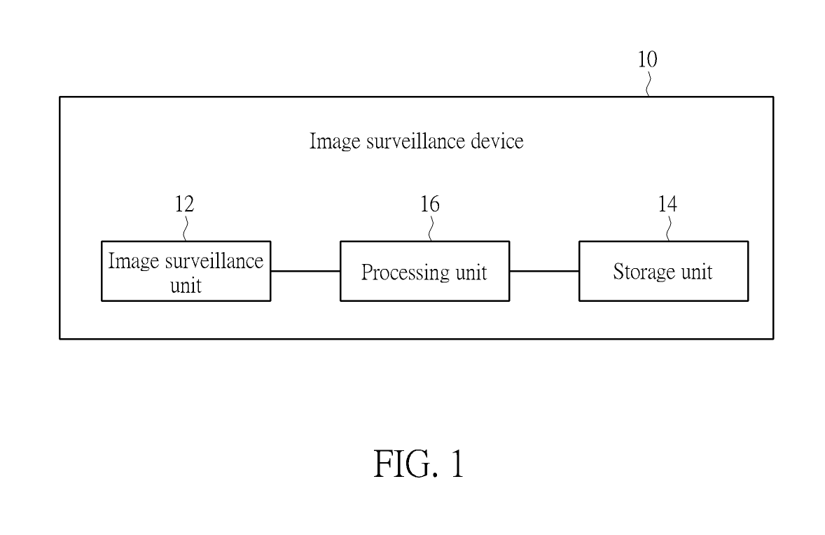

Please refer to FIG. 1, which is a functional block diagram of an image surveillance device 10 according to an embodiment of the present invention. As shown in FIG. 1, the image surveillance device 10 includes at least one image surveillance unit 12 (one shown in FIG. 1, but not limited thereto, meaning that the image surveillance device 10 could utilize a plurality of image surveillance units to monitor a plurality of surveillance regions respectively), a storage unit 14, and a processing unit 16. The image surveillance unit 12 could preferably be a camera device with a pan-tilt-zoom function for performing a dynamic surveillance operation on specific targets in a surveillance region for capturing surveillance images, such as a speed dome camera, but not limited thereto. The storage unit 14 could be a storage media (e.g. a memory card or a hard disk drive) commonly applied to a camera device for storing surveillance list information. The processing unit 16 is electrically connected to the image surveillance unit 12 and the storage unit 14 for setting a priority of each target in advance according to the surveillance list information, and is used for controlling the image surveillance unit 12 to identify one of the targets according to the stored surveillance list information to obtain a priority of the one of the targets when the one of the targets enters a surveillance region monitored by the image surveillance unit 12. Accordingly, the processing unit 16 could determine whether to control the image surveillance unit 12 to monitor the aforesaid target according to the priority of the aforesaid target.

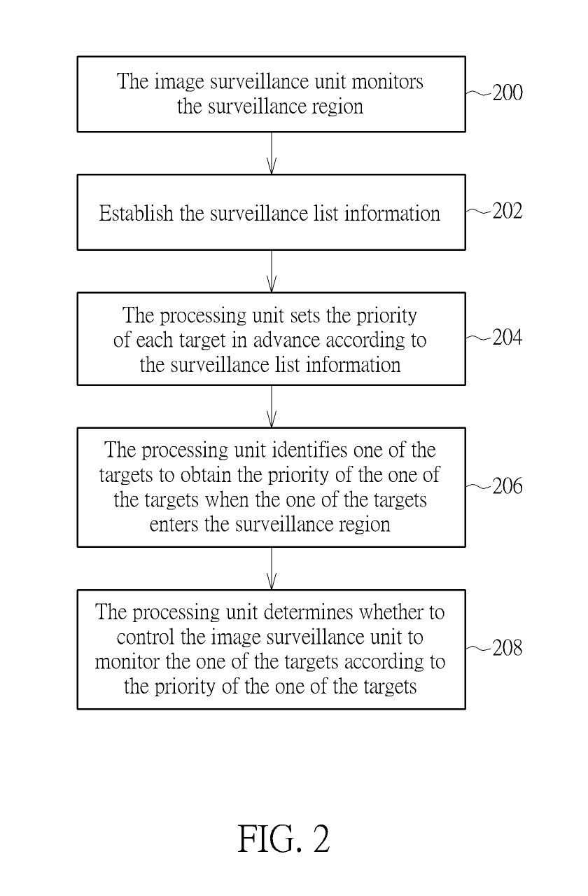

Please refer to FIG. 1 and FIG. 2. FIG. 2 is a flowchart of an image surveillance method according to an embodiment of the present invention. The image surveillance method of the present invention includes the following steps.

Step 200: The image surveillance unit 12 monitors the surveillance region;

Step 202: Establish the surveillance list information;

Step 204: The processing unit 16 sets the priority of each target in advance according to the surveillance list information;

Step 206: The processing unit 16 identifies one of the targets to obtain the priority of the one of the targets when the one of the targets enters the surveillance region;

Step 208: The processing unit 16 determines whether to control the image surveillance unit 12 to monitor the one of the targets according to the priority of the one of the targets.

More detailed description for the aforesaid steps is provided as follows. In step 200, the image surveillance unit 12 could monitor the surveillance region (e.g. a user's home) for providing surveillance images to the user. In practical application, the user could manually input the surveillance list information (e.g. images of the elderly and children or identity information) corresponding to the targets into the storage unit 14 (but not limited thereto), and then the image surveillance unit 12 could monitor the surveillance region according to the surveillance list information stored in the image surveillance device 10 (Step 202).

Subsequently, in Step 204, the processing unit 16 could set the priority of each target in advance according to the aforesaid surveillance list information as a surveillance reference of determining which target needs to be preferentially monitored. In practical application, the priority setting step could be performed according to the practical surveillance needs for the user. For example, the elderly or a child who needs special care could be set as a target having a relatively higher priority. In such a manner, when one of the targets in the surveillance list information enters the surveillance region, the processing unit 16 could identify the one of the targets according to the surveillance list information to obtain the priority of the one of the targets (Step 206). To be noted, the processing unit 16 could identify the one of the targets by a conventional identification method, such as an image identification method (e.g. image contour identification) or an identity identification method (e.g. identifying the identity of the one of the targets via a Bluetooth wristband on the one of the targets), but not limited thereto, meaning that all methods for target identification could be adopted by the present invention.

Finally, the processing unit 16 could determine whether to control the image surveillance unit 12 to monitor a target entering the surveillance region according to a corresponding priority of the target (Step 208). To be more specific, if only one target enters the surveillance region, the processing unit 16 could determine whether to control the image surveillance unit 12 to monitor this target entering the surveillance region according to the priority of this target. For example, when the processing unit 16 determines that the priority of this target is higher than a specific value (could be a system default value or a user defined value), the processing unit 16 could control the image surveillance unit 12 to monitor this target. On the other hand, if there are multiple targets entering the surveillance region, the processing unit 16 could determine which target is preferentially monitored according to the priorities of these targets. For example, the processing unit 16 could control the image surveillance unit 12 to monitor the target having the highest priority, so as to ensure that the image surveillance device 10 could preferentially monitor the target having a high priority.

Furthermore, as mentioned above, the image surveillance device 10 of the present invention could be applied to monitoring of multiple targets in multiple surveillance regions. For example, when one of the targets enters a second surveillance region from a first surveillance region where the one of the targets is originally located, the processing unit 16 could compare the priority of this target with the priorities of other targets originally located in the second surveillance region, so as to determine whether to control the image surveillance unit 12 set for monitoring the second surveillance region to preferentially monitor this target. That is, when the processing unit 16 determines that the priority of this target is higher than the priorities of the other targets originally in the second surveillance region, the processing unit 16 controls the image surveillance unit 12 set for monitoring the second surveillance region to preferentially monitor this target. On the contrary, when the processing unit 16 determines that the priority of this target is less than the priorities of the other targets originally in the second surveillance region, the processing unit 16 controls the image surveillance unit 12 set for monitoring the second surveillance region to keep monitoring the target having a relatively higher priority originally in the second surveillance region. In summary, all the designs in which identification of a target could be performed when the target enters the surveillance region and whether to preferentially monitor the target is determined according to the priority of the target could fall within the scope of the present invention.

It should be mentioned that the image surveillance device 10 could preferentially monitor a major target defined by the user during a specific period of time. That is, the user could set a priority of the major target (e.g. the elderly at home in the daytime or a child at home in the evening) entering the surveillance region during the specific period of time to a maximum value. Accordingly, when the major target enters the surveillance region during the specific period of time, the processing unit 16 identifies the major target to obtain the maximum priority, and then controls the image surveillance unit 12 to preferentially monitor the major target according to the maximum priority, so as to ensure that the image surveillance device 10 could preferentially monitor the target of interest during the specific period of time. In such a manner, the image surveillance device 10 could provide surveillance images of the target of interest to the user immediately when the user accesses the surveillance images captured by the image surveillance unit 12, so as to greatly improve practicability of the image surveillance device 10 in image surveillance.

Moreover, the image surveillance device 10 could be used for preferentially monitoring an unexpected target (e.g. a thief attempting to break into the house). That is, when the processing unit 16 determines that an unexpected target entering the surveillance region does not match the aforesaid surveillance list information, which means that the unexpected target is not any one of the targets in the surveillance list information, the processing unit 16 could be further used for controlling the image surveillance unit 12 to preferentially monitor this unexpected target, so as to achieve the anti-theft purpose.

Compared with the prior art, the present invention adopts the design in which identification of a target could be performed when the target enters the surveillance region and whether to preferentially monitor the target is determined according to the priority of the target, to achieve the purpose that the image surveillance device of the present invention could preferentially monitor the target having a high priority. In such a manner, the present invention could efficiently solve the prior art problem that the surveillance camera may monitor other targets instead of monitoring the target of interest due to interference of other sudden events, so as to ensure that the image surveillance device could preferentially monitor the target having the relatively highest priority (i.e. the target of interest) in the surveillance region. Furthermore, the image surveillance device of the present invention could provide the surveillance images of the target of interest to the user immediately when the user accesses the surveillance images captured by the image surveillance device, so as to greatly improve practicability of the image surveillance device in image surveillance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image surveillance method for surveillance of a plurality of targets, the image surveillance method comprising:
setting a priority of each target in advance;
identifying at least one of the plurality of targets to obtain the priority of the at least one of the plurality of targets when the at least one of the plurality of targets enters at least one surveillance region; and
determining whether to monitor the at least one of the plurality of targets according to the priority of the at least one of the plurality of targets.

2. The image surveillance method of claim 1 further comprising:
utilizing at least one image surveillance device to monitor the at least one surveillance region;
establishing a surveillance list information corresponding to the plurality of targets; and
setting the priority of each target in advance according to the surveillance list information.

3. The image surveillance method of claim 2, wherein the plurality of targets comprises at least one major target, and the step of setting the priority of each target in advance according to the surveillance list information comprises:
setting a priority of the at least one major target to a maximum value during at least one specific period of time;
wherein when the at least one major target enters the at least one surveillance region during the at least one period of time, the at least one image surveillance device identifies the at least one major target according to the surveillance list information to obtain the priority of the at least one major target and preferentially monitors the at least one major target according to the priority of the at least one major target.

4. The image surveillance method of claim 2 further comprising:
the at least one image surveillance device preferentially monitor an unexpected target when the at least one image surveillance device determines that the unexpected target entering the at least one surveillance region does not match the surveillance list information.

5. The image surveillance method of claim 2, wherein the surveillance list information comprises an identification image of each target, and when the at least one of the plurality of targets enters the at least one surveillance region, the at least one image surveillance device identifies the at least one of the plurality of targets by an image identification method according to the identification image of each target, so as to obtain the priority of the at least one of the plurality of targets.

6. The image surveillance method of claim 2, wherein when the at least one of the plurality of targets enters the at least one surveillance region, the at least one image surveillance device identifies the at least one of the plurality of targets by an identity identification method according to the surveillance list information, so as to obtain the priority of the at least one of the plurality of targets.

7. An image surveillance device comprising:
at least one image surveillance unit for monitoring at least one surveillance region; and
a processing unit electrically connected to the at least one image surveillance unit for setting a priority of each target according to the surveillance list information, controlling the at least one image surveillance unit to identify at least one of a plurality of targets to obtain the priority of the at least one of the plurality of targets when the at least one of the plurality of targets enters the at least one surveillance region, and determining whether to control the at least one image surveillance unit to monitor the at least one of the plurality of targets according to the priority of the at least one of the plurality of targets.

8. The image surveillance device of claim 7, wherein the image surveillance device further comprises:
a storage unit for storing a surveillance list information corresponding to the plurality of targets;
wherein the processing unit is used for setting the priority of each target according to the surveillance list information in advance and controlling the at least one image surveillance unit to identify at least one of the plurality of targets according to the surveillance list information to obtain the priority of the at least one of the plurality of targets when the at least one of the plurality of targets enters the at least one surveillance region.

9. The image surveillance device of claim 8, wherein the plurality of targets comprises at least one major target, and when the at least one major target enters the at least one surveillance region during the at least one period of time, the processing unit is used for setting the priority of the at least one major target to a maximum value during at least one period of time and controlling the at least one image surveillance unit to identify the at least one major target according to the surveillance list information to obtain the priority of the at least one major target and to preferentially monitor the at least one major target according to the priority of the at least one major target.

10. The image surveillance device of claim 8, wherein the processing unit is further used for controlling the at least one image surveillance unit to preferentially monitor an unexpected target when the processing unit determines that the unexpected target entering the at least one surveillance region does not match the surveillance list information.

11. The image surveillance device of claim 8, wherein the surveillance list information comprises an identification image of each target, and when the at least one of the plurality of targets enters the at least one surveillance region, the processing unit is used for controlling the at least one image surveillance unit to identify the at least one of the plurality of targets by an image identification method according to the identification image of each target, so as to obtain the priority of the at least one of the plurality of targets.

12. The image surveillance device of claim 8, wherein when the at least one of the plurality of targets enters the at least one surveillance region, the processing unit is used for controlling the at least one image surveillance unit to identify the at least one of the plurality of targets by an identity identification method according to the surveillance list information, so as to obtain the priority of the at least one of the plurality of targets.
